(19) United States
(12) Patent Application Publication
(10) Pub. No.: US 2009/0174918 A1
(43) Pub. Date: Jul. 9, 2009

(54) ELECTRICALLY-CONTROLLED, VARIABLE FOCAL LENGTH H-PDLC OPTICAL IMAGING APPARATUS AND METHOD

(75) Inventors: Songlin Zhuang, Shanghai (CN); Jihong Zheng, Shanghai (CN)

Correspondence Address: Curtis A. Vock;LATHROP & GAGE LLP, 4845 Pearl East Circle, Suite 201, Boulder, CO, 80301, US

(73) Assignee: OMNIVISION TECHNOLOGIES, INC., Sunnyvale, CA (US)

(21) Appl. No.: 11/971,129

(22) Filed: Jan. 8, 2008

(51) Int. Cl. G02B 5/32

(52) U.S. Cl. 359/19

(57) ABSTRACT

An optical imaging apparatus having a variable focal length is disclosed. A plurality of holographic polymer dispersed liquid crystal (“H-PDLC”) lenses are arranged in a stack, each lens having a unique focal length. A controller is configured to program a plurality of voltages applied to the plurality of H-PDLC lenses to achieve a plurality of focal lengths, the plurality of focal lengths higher than the plurality of H-PDLC lenses.

### BRIEF DESCRIPTION OF THE INVENTION

This invention relates generally to H-PDLC lenses. More particularly, this invention relates to an electrically-controlled, variable focal length optical imaging apparatus based on H-PDLC lenses.

### BACKGROUND OF THE INVENTION

Optical lenses are optical devices that refract light to form an image of an object. They are fundamental components of any imaging system, including viewing devices such as glasses, binoculars and telescopes, scientific instruments such as microscopes and spectroscopes, analog and digital cameras, video cameras, medical devices such as optical catheter and endoscopes, and the like. There are many types of optical lenses available today, manufactured from various materials and having different characteristics. Selecting a lens for use in an imaging device depends mostly on how the lens' characteristics enable the device to perform its specialized functions.

One of the most decisive characteristics is the lens' focal length. The focal length of an optical lens is a measure of how strongly it converges (i.e., focuses) or diverges (i.e., diffuses) light. Light rays from a distant object enter a lens and converge into a region called the focal point. The distance between the center of the lens and the focal point is the focal length. In cameras, for example, the lenses are separated from the film or image sensor by their focal length.

The focal length of a lens is determined by the curvature, thickness and type of materials used in the lens. Short focal lengths yield wider angles of view and higher magnification. A lens with a shorter focal length also has greater optical power than one with a long focal length. In a camera, this translates into the amount of scene that is captured in the film or sensor. Lenses with shorter focal length are able to capture more of an image scene than lenses with longer focal length. Smaller objects require shorter focal lengths and vice-versa.

The focal length of a lens may therefore need to be adjusted in many imaging devices in order to properly capture an image of an object. Lenses having fixed focal lengths may typically require a mechanical or other optical assembly to move the lenses so images are captured with the appropriate magnification. In a camera, for example, the focal length may be adjusted by moving the lens closer or farther away from the film or image sensor. As the lens is moved, an image of an object can be lined up so it falls directly on the film or image sensor. The main disadvantages are that the assembly together with the lens may be heavy and slow to adjust.

An alternative approach is to use lenses having variable focal lengths. Such lenses may have a variable surface or material and be difficult to manufacture. For example, variable focal length lenses are described in U.S. Pat. Nos. 7,277,234, 7,215,480, 7,245,440, and 7,042,549.

In U.S. Pat. No. 7,277,234, a zoom lens system having four sub-lenses is disclosed. The zoom lens system provides a variable focal length by changing the distance between the sub-lenses. The sub-lenses themselves have fixed focal lengths but are arranged to provide a range of varying focal lengths. Zoom lens systems, however, are in general notoriously heavy and slow. Their performance is severely limited by the speed in which the sub-lenses can be moved relative to each other.

In U.S. Pat. No. 7,215,480, a liquid crystal lens having a variable focal length is described. The liquid crystal lens has a body containing an electromagnetic field generator that changes the focal length of the light passage region by moving, by electromagnetic force, light-transmissive nanoparticles that are dispersed in a light-transmissive dispersion medium enclosed in a container having the shape of a lens. A focal length adjustment section coupled to the lens body changes the focal length of the lens by controlling an electromagnetic field generated by the electromagnetic field generator. A moving mechanism is still required for moving the lens in the optical axis direction for focusing.

Another liquid crystal lens having a variable focal length is described in U.S. Pat. No. 7,245,440. The lens disclosed therein has a chamber containing a conductive liquid and an insulating liquid of different refractive indexes. The two liquids contact one another to form a deformable refractive interface having a periphery that is caused to move along the wall of the lens housing as a function of an applied electric voltage. The applied voltage can be tuned to change the curvature of the interface, which in turn changes the focal length of the lens. Despite its lack of moving parts, this lens is complex to manufacture and requires a relatively high voltage in order to alter the characteristics of the liquid interface.

Another liquid crystal lens having no moving parts is described in U.S. Pat. No. 7,042,549. The lens disclosed therein uses nano-scale polymer-dispersed liquid crystal droplets (“PDLC”) with refractive indexes that can be shaped by an applied voltage, which tunes the focal length of the lens. The PDLC droplets are supported between glass substrates, where they are mixed within a polymer matrix and held in position between sandwiched glass or plastic substrates.

The use of PDLC materials in imaging devices has recently increased. PDLC materials can be electrically controlled with an applied voltage, which makes them suitable to control many different optical characteristics, including the focal length of a lens. One type of PDLC material that has been popular in many applications includes Holographically formed PDLC (“H-PDLC”). H-PDLC are periodic dielectric structures consisting of alternating PDLC and solid polymer layers. When power is applied to an H-PDLC material, its liquid crystals are regularly arranged in a specific pattern and incident light passes through it without diffraction. Conversely, when no power is applied to an H-PDLC material, the liquid crystals are irregularly arranged and light diffraction occurs due to the difference of refraction rates of the liquid crystals and the polymer. For an H-PDLC material to function as a lens, a specific hologram pattern is printed thereon.

H-PDLCs are considered to be one of the most viable technologies for the development of reflective color displays, switchable holographic optical elements such as Bragg gratings for photonic devices including wavelength division multiplexing devices, light modulators and variable focal lenses, among others. In particular, variable focal lenses using H-PDLC materials have the potential to provide high performance results such as a fast response time and a low operating voltage in a small, easy to manufacture package.

For example, United States Patent Publication Number 2007/0008599 discloses a variable focal length lens having three H-PDLC layers. In the example provided, three H-PDLC layers are used to provide a multi-focal lens for recording information in a CD, DVD, and BD (with each H-PDLC layer corresponding to a given optical recording medium). Each H-PDLC layer has a Computer Generated Hologram (“CGH”) which serves as the plane lens and determines its focal length for focusing light at the focal point suitable for recording onto the corresponding recording medium. Information may be recorded in a given medium by turning off the H-PDLC layer corresponding to that medium (so that light is diffracted through it) and turning on the H-PDLC layers corresponding to the other two mediums (so no diffraction occurs and the other two mediums are transparent.) Light is emitted from a light source configured to generate a light according to the characteristic of each recording medium and placed at a fixed distance from the H-PDLC layers.

To record information in a DVD, for example, electrical power is applied to the H-PDLC layers corresponding to the CD and BD recording mediums so that they become transparent when passing through the incident light. No power is applied to the H-PDLC layer corresponding to the DVD. The incident light is then diffracted by the CGH printed thereon and focused on the focal point corresponding to the focal length of that H-PDLC layer. Information may be similarly recorded in the other two recording mediums. This way, three different focal lengths may be provided, one corresponding to each recording medium.

The lens provided is therefore limited as to the number of focal lengths it supports. The number of focal lengths achievable corresponds to the number of H-PDLC layers it embodies, e.g., three focal lengths are achievable for three H-PDLC layers. Providing additional focal lengths requires additional H-PDLC layers. Such a lens is thus not easily scalable as many H-PDLC layers are needed to support a wide range of focal lengths.

Accordingly, it would be desirable to provide a variable focal length H-PDLC imaging apparatus that is capable of focusing light at a wide range of focal lengths. In particular, it would be desirable to provide a variable focal length H-PDLC imaging apparatus that can be programmed to realize a wide range of focal lengths.

### SUMMARY OF THE INVENTION

The invention includes an optical imaging apparatus having a variable focal length. A plurality of holographic polymer dispersed liquid crystal (“H-PDLC”) lenses are arranged in a stack, each lens having a unique focal length. A programmable controller is configured to independently address a plurality of voltages to the plurality of H-PDLC lenses to achieve a plurality of focal lengths, the number of focal lengths greater than the number of H-PDLC lenses.

An embodiment of the invention includes an integrated multi-lens apparatus. The apparatus includes N integrated lens layers, each layer having a holographic polymer dispersed liquid crystal lens having a unique focal length. The apparatus also includes a programmable controller configured to apply N voltages to the N integrated lens layers to achieve 2^{N} foc al lengths, wherein N is an integer of at least two.

Another embodiment of the invention includes a method of fabrication of an optical imaging apparatus having a variable focal length. A plurality of holographic polymer dispersed liquid crystal (“H-PDLC”) lenses are fabricated, each lens having a unique focal length. The plurality of H-PDLC lenses are stacked in a package. A programmable controller is provided in the package to apply a plurality of voltages to the plurality of H-PDLC lenses to achieve a plurality of focal lengths, the number of focal lengths greater than the number of H-PDLC lenses.

A further embodiment of the invention includes a programmable multi-focal camera. The programmable multi-focal camera has an image sensor to generate image data from an optical image and a programmable optical assembly to capture the optical image. The programmable optical assembly has a plurality of holographic polymer dispersed liquid crystal (H-PDLC) lenses arranged in a stack, each lens having a unique focal length, and a programmable controller configured to independently address a plurality of voltages to the plurality of H-PDLC lenses to achieve a plurality of focal lengths, the number of focal lengths greater than the number of H-PDLC lenses.

### BRIEF DESCRIPTION OF THE DRAWINGS

The invention is more fully appreciated in connection with the following detailed description taken in conjunction with the accompanying drawings, in which like reference characters refer to like parts throughout, and in which:

FIG. 1 illustrates an optical imaging apparatus constructed according to an embodiment of the invention;

FIG. 2 illustrates a PDLC cell for use with an H-PDLC lens of the apparatus of FIG. 1;

FIGS. 3A and 3B illustrate two states of an H-PDLC lens;

FIG. 4 illustrates a flow chart for fabricating an optical imaging apparatus in accordance with an embodiment of the invention;

FIG. 5 illustrates a flow chart for fabricating a plurality of H-PDLC lenses in accordance with an embodiment of the invention;

FIG. 6 illustrates a schematic diagram of an optical setup for recording a holographic fringe in a PDLC cell in accordance with an embodiment of the invention;

FIGS. 7A-B illustrate the different focal lengths generated by red and blue light in an off-axis H-PDLC lens (FIG. 7A) and in a fixed lens (FIG. 7B);

FIG. 8 illustrates an optical imaging apparatus constructed according to another embodiment of the invention; and

FIG. 9 illustrates a programmable camera constructed according to an embodiment of the invention.

### DETAILED DESCRIPTION OF THE INVENTION

An optical imaging apparatus including a plurality of H-PDLC lenses is provided. As generally used herein, an H-PDLC lens may be any lens made of Holographic Polymer Liquid Crystals. According to an embodiment of the invention, each H-PDLC lens in the optical imaging apparatus has a unique focal length. A lens' focal length, as generally used herein, may be the length between the center of the lens and its focal point, which is the point of conversion of incident light rays.

According to an embodiment of the invention, each H-PDLC lens also has two unique states, “ON” and “OFF,” depending on whether power is applied to it. When power is applied to an H-PDLC lens, incident light passes through it without diffraction and the H-PDLC lens is said to be in an “ON” state. Conversely, when no power is applied to an H-PDLC lens, diffraction occurs and the H-PDLC lens is said to be in an “OFF” state.

The optical imaging apparatus also includes a controller for programming a plurality of voltages applied to the plurality of H-PDLC lenses to achieve a plurality of focal lengths. In particular, the controller is configured to apply a combination of voltages that achieve 2^{N} focal lengths for N H-PDLC lenses. The combination of voltages includes a combination of ON and OFF AC voltages corresponding to the ON and OFF states of an H-PDLC lens.

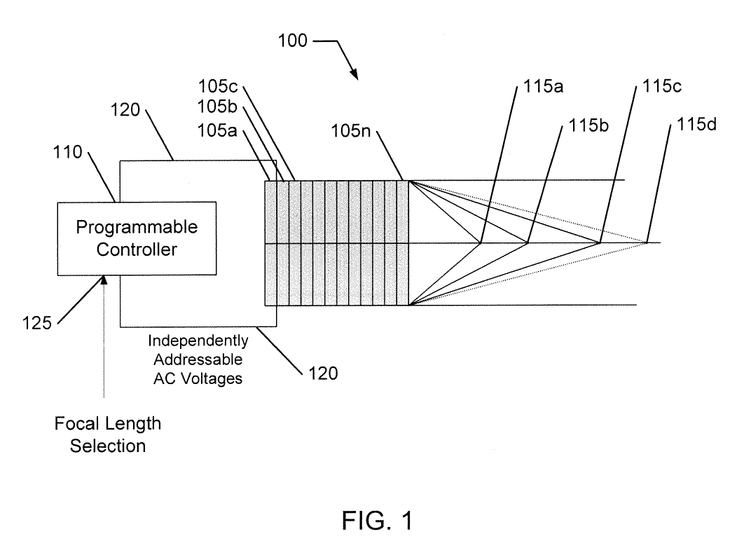

An optical imaging apparatus constructed according to an embodiment of the invention is illustrated in FIG. 1. Optical imaging apparatus 100 has a plurality of H-PDLC lenses 105a-n and a programmable controller 110. In one embodiment, optical imaging apparatus 100 includes N H-PDLC lenses, where N is an integer of at least 2. In one embodiment, each H-PDLC lens 105a-n is an on-axis diffractive lens so that light diffracting from the lens has the same direction as the light incident thereon.

According to an embodiment of the invention, each H-PDLC lens 105a-n has a unique focal length corresponding to unique focal points 11 5a-n. Each H-PDLC lens 105a-n is also connected to controller 110. Programmable controller 110 is configured to apply a plurality of AC voltages 120 to the plurality of H-PDLC lenses 105a-n so that each of H-PDLC lenses 105a-n is on its ON or OFF state.

The plurality of AC voltages 120 are independently addressable, i.e., each AC voltage applied to each H-PDLC lens is independent from the others. In one embodiment, programmable controller 110 has a focal length selection input 125 for enabling a user to select the combination of AC voltages 120 to be applied to the H-PDLC lenses 105a-n for achieving a particular focal length.

As described above, an H-PDLC lens 105a-n is in its ON state when it receives an AC voltage so that its liquid crystals are regularly arranged in a specific pattern and incident light passes through it without diffraction. Conversely, an H-PDLC lens 105a-n is in its OFF state when no power is applied to it. In this case, the liquid crystals are irregularly arranged and light diffraction occurs due to the difference of refraction rates of the liquid crystals and the polymer in the lens.

In one embodiment, programmable controller 110 is programmed to apply 2^{N} combinations of ON and OFF AC voltages to the N H-PDLC lenses 105a-n. For example, for N=3, that is, for 3 H-PDLC lenses such as H-PDLC lenses (105a,105b,105c), programmable controller 110 may apply a total of eight combinations of ON and OFF AC voltages, namely: (1) (ON,ON,ON); (2) (ON, ON, OFF); (3) (ON,OFF,ON); (4) (OFF,ON,ON); (5) (ON,OFF,OFF); (6) (OFF,ON,OFF); (7) (OFF,OFF,ON); and (8) (OFF,OFF,OFF).

One of ordinary skilled in the art appreciates that an OFF AC voltage corresponds to no AC voltage being applied to an H-PDLC lens, i.e., the H-PDLC lens does not receive any power. Conversely, an ON AC voltage corresponds to an AC voltage being applied to an H-PDLC lens that causes it to behave in its ON state. In one embodiment, the AC voltages 120 may be between 5 and 50 V.

In one embodiment, the plurality of H-PDLC lenses 105a-n are stacked together in a package with no spacing between them. In this embodiment, programmable controller 110 is integrated with the lenses in the package.

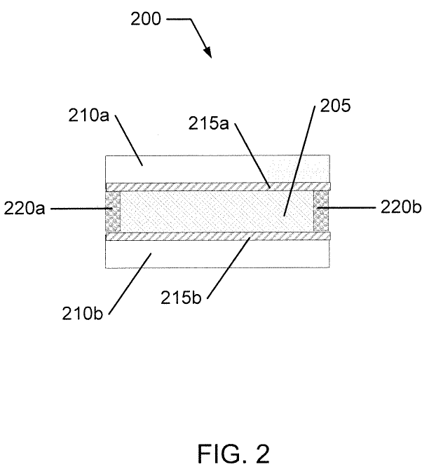

A PDLC cell for use with an H-PDLC lens of the apparatus of FIG. 1 is illustrated in FIG. 2. An H-PDLC lens is formed with a PDLC cell such as PDLC cell 200. PDLC cell 200 includes a holographic polymer dispersed liquid crystal layer 205 sandwiched between upper glass substrate 210a and lower glass substrate 210b. In one embodiment, upper and lower glass substrates 210a-b may be Indium Tin Oxide (“ITO”) glass substrates. Upper and lower glass substrates 210a-b are oppositely disposed within a given predetermined distance. In one embodiment, holographic polymer dispersed liquid crystal layer 205 has a thickness ranging from 5 to 10 μm.

PDLC cell 200 also includes electrodes 215a-b for receiving electrical power from controller 110. Electrodes 215a-b are disposed on each inner surface of glass substrates 210a-b, respectively.

Holographic polymer dispersed liquid crystal layer 205 includes a polymer with liquid crystals dispersed thereon, such as liquid crystals 220a-b. When power is applied to electrodes 215a-b, liquid crystals 220a-b are regularly arranged in a pattern and incident light passes through PDLC cell 200 without diffraction. PDLC cell 200 is then said to be in its “ON” state. When no power is applied to electrodes 215a-b, liquid crystals 220a-b are irregularly arranged and light diffraction occurs due to the different indices of refraction of liquid crystals 220a-b and polymer. PDLC cell 200 is then said to be in its “OFF” state.

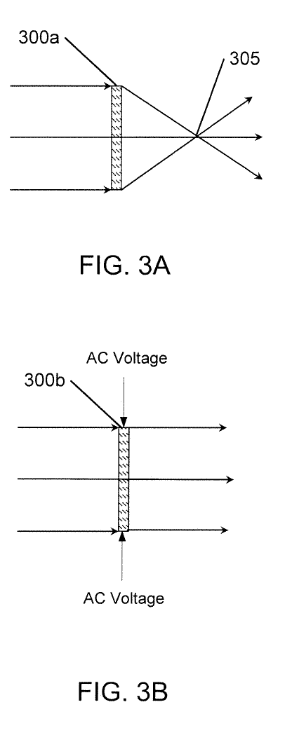

The states of an H-PDLC lens are illustrated in FIGS. 3A and 3B. H-PDLC lens 300a is an H-PDLC lens that receives no electrical power, i.e., no electrical power is applied to its electrodes. As shown in FIG. 3A, light incident onto H-PDLC lens 300a is diffracted as a result of the different refraction rates of its liquid crystals and polymer. The diffracted light converges at focal point 305, the position of which depends on the holographic fringe recorded onto H-PDLC lens 300, as described in more detail herein below.

H-PDLC 300b is an H-PDLC lens that receives electrical power applied to its electrodes. As shown in FIG. 3B, light incident onto H-PDLC lens 300b transmits straight through it without any diffraction, that is, H-PDLC lens 300b acts as a transparent medium.

According to the present invention, stacking H-PDLC lens 300a with H-PDLC lens 300b results in a variable focal lens that has 4 different focal lengths. For example, if no power is applied to H-PDLC lens 300a and power is applied to H-PDLC lens 300b as illustrated in FIGS. 3A-B, then the stacked lens has a focal length corresponding to the focal length of H-PDLC 300a. Similarly, if power is applied to H-PDLC lens 300a and no power is applied to H-PDLC lens 300b, then the stacked lens has a focal length corresponding to the focal length of H-PDLC 300b.

The other two focal lengths may be obtained by applying power to both H-PDLC lenses 300a-b or neither one of them. In the first case, i.e., when power is applied to both H-PDLC lenses 300a-b, the resulting focal length is a focal length shorter than either one of the individual lenses' focal length. In the latter case, i.e., when power is applied to neither one of H-PDLC lenses 300a-b, the focal length is approximately infinity, that is, the stacked lens acts as a transparent medium and light is transmitted through it.

One of ordinary skilled in the art then appreciates that when N H-PDLC lenses are stacked together according to an embodiment of the invention, optical imaging apparatus 100 achieves 2^{N} focal lengths.

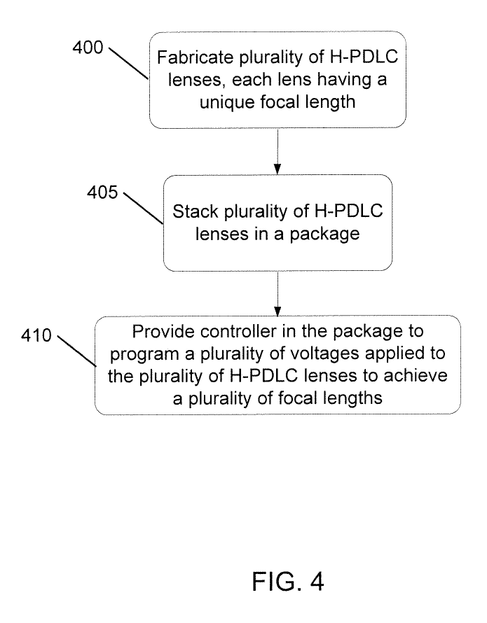

Referring now to FIG. 4, a flow chart for fabricating an optical imaging apparatus in accordance with an embodiment of the invention is described. First, a plurality of H-PDLC lenses are fabricated, with each lens having a unique focal length (400). Next, the plurality of H-PDLC lenses are stacked in a package (405). A programmable controller is then integrated into the package to apply a plurality of independently addressable AC voltages to the plurality of H-PDLC lenses to achieve a plurality of focal lengths. As discussed above, the use of N H-PDLC lenses yields 2^{N} unique focal lengths.

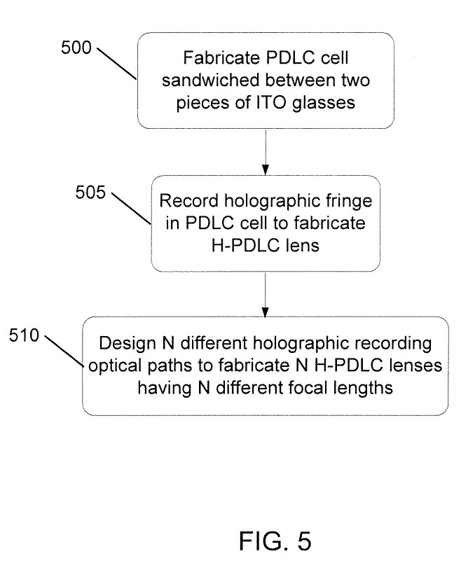

A flow chart for fabricating a plurality of H-PDLC lenses in accordance with an embodiment of the invention is shown in FIG. 5. Each H-PDLC lens is formed from a PDLC cell. The PDLC cell is fabricated with a PDLC material sandwiched between two glass substrates, such as ITO glass substrates (500). In one embodiment, the PDLC material has a thickness ranging from 5 to 10 μm.

Each H-PDLC lens is made by recording a holographic fringe in a PDLC cell (505). Different holographic fringes are recorded with different holographic recording paths to fabricate different H-PDLC lenses (510). For example, N different holographic recording paths may be used to fabricate N different H-PDLC lenses. In one embodiment, the holographic fringe recorded on the PDLC cell produces light diffraction when an AC voltage is applied to the H-PDLC lens. In one embodiment, the AC voltage may range from 5 to 50 V.

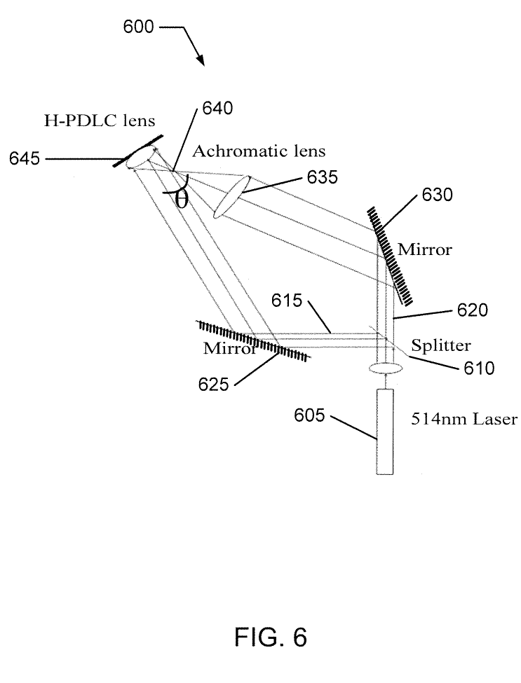

FIG. 6 illustrates a schematic diagram of an optical setup for recording an holographic fringe in a PDLC cell in accordance with an embodiment of the invention. Optical setup 600 includes laser 605 and splitter 610 to produce coherent laser beams 615 and 620. Laser beam 615 corresponds to the object light and laser beam 620 corresponds to a reference beam. In one embodiment, laser 605 may be an Argon laser with a wavelength ranging from 120 to 530 nm.

Laser beams 615-620 are emitted through mirrors 625-630 to induce phase separation between the polymer and liquid crystal in the PDLC cell, such as PDLC cell 200 shown in FIG. 2. The phase separation causes the liquid crystal droplets to concentrate on a dark holographic fringe area, interspersed by bright regions of polymer binder. Achromatic lens 635 focuses laser beam 620 into focus point 640. Laser beam 620 is then dispersed into an equal area of lens 645. As a result, an H-PDLC diffractive optical element is formed thereon.

The focal length of H-PDLC lens 645 is determined by the distance from focus point 640 to the exposure surface, i.e., to lens 645, the recording wavelength of laser 605, and the reconstruction wavelength of the holographic fringe being recorded. H-PDLC lenses having different focal lengths can therefore be produced by changing the distance between achromatic lens 635 and H-PDLC lens 645. The angle Θ between laser beams 615-620 determines the spatial frequency of the holographic fringe and H-PDLC lens 645. In one embodiment, Θ may range from 17°-19° to obtain a high diffraction efficiency. The exposure time for recording the holographic fringe may be as short as 40-60 seconds.

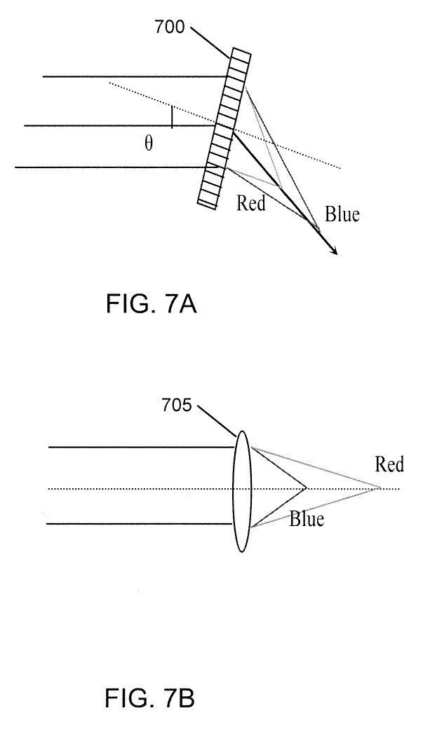

Optical recording apparatus 600 may be used to produce on-axis H-PDLC lenses such as those used in optical imaging apparatus 100 as well as to produce off-axis H-PDLC lenses. One of ordinary skill in the art appreciates that an on-axis H-PDLC lens has a lower diffraction efficiency than an off-axis H-PDLC lens. One of ordinary skill in the art also appreciates that H-PDLC lenses may suffer from chromatic aberration. For example, FIG. 7A shows off-axis H-PDLC lens 700 having a shorter red focus length than a blue focus length. In comparison, normal glass lens 705 in FIG. 7B has a shorter blue focus length than a red focus length.

To improve the diffraction efficiency of the optical imaging apparatus 100 of the invention, off-axis H-PDLC lenses may be used. However, this results in light diffracting from the H-PDLC lenses having a different direction from the light incident thereon. The light direction can be adjusted by inserting a prism after the stack of H-PDLC lenses in the optical imaging apparatus package. A fixed lens can also be inserted in the package (in front of the H-PDLC lenses' stack) to subtract chromatic aberration and enhance the light focus ability of the optical imaging apparatus.

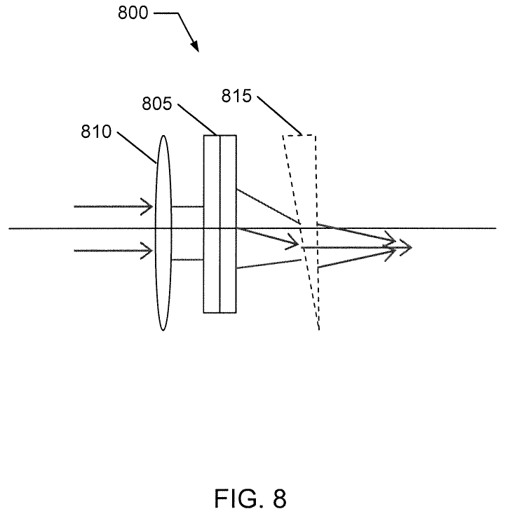

Another embodiment of the optical imaging apparatus is thus illustrated in FIG. 8. Optical imaging apparatus 800 includes a plurality of off-axis H-PDLC lenses 805, fixed lens 810 placed in front of the plurality of off-axis H-PDLC lenses 805, and prism 815 placed after the plurality of H-PDLC lenses 805. The plurality of off-axis H-PDLC lenses 805, fixed lens 810 and prism 815 are integrated together in a single package. The package also includes a programmable controller (not shown) for applying a plurality of independently addressable AC voltages to the plurality of H-PDLC lenses 805 as described above.

It is appreciated that optical imaging apparatuses 100 and 800 are shown for illustration purposes only. Other optical elements may be inserted in the packages corresponding to apparatuses 100 and 800 without deviating from the scope and principles of the invention. For example, additional fixed lenses and prisms may be inserted in the packages to further reduce the chromatic aberration and improve the light direction of the apparatuses. Further, optical imaging apparatuses 100 and 800 may be built with on-axis H-PDLC lenses only, off-axis H-PDLC lenses, or a combination of on-axis and off-axis H-PDLC lenses.

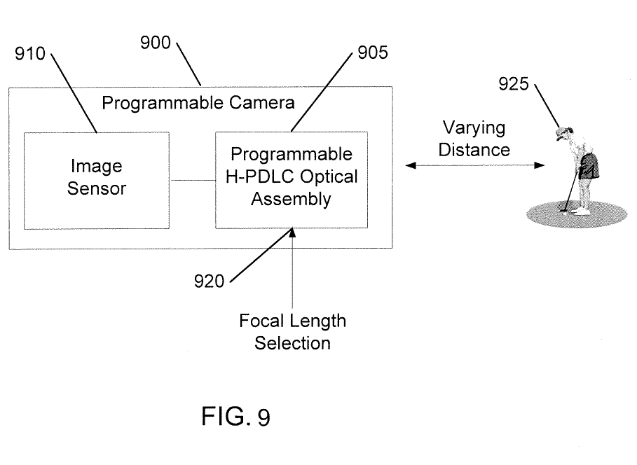

Referring now to FIG. 9, a programmable camera constructed according to an embodiment of the invention is described. Programmable camera 900 includes programmable H-PDLC optical assembly 905 for capturing an optical image and image sensor 910 for generating image data (i.e., pixel data) from the optical image. Programmable H-PDLC optical assembly 905 includes an optical imaging apparatus having a stack of H-PDLC lenses and a programmable controller such as, for example, optical imaging apparatuses 100 and 800 described above.

According to an embodiment of the invention, programmable camera 900 is a multi-focal camera achieving a wide range of focal lengths (i.e., 2^{N} focal lengths for N H-PDLC lenses.) A user may select one of the focal lengths via focal selection input 120 of programmable H-PDLC optical assembly 905. The multiple focal lengths allow programmable camera 900 to capture images at varying distances, such as image 925, with a fast speed and easily programmable multi-focal H-PDLC lens.

Advantageously, the optical imaging apparatus of the invention provides multiple focal lengths in a single, small and efficient package that can be programmed and electrically controlled to provide fast focal speed and accuracy. The package may be used in a variety of imaging devices, including, but not limited to, viewing devices such as glasses, binoculars and telescopes, scientific instruments such as microscopes and spectroscopes, analog and digital cameras, video cameras, medical devices such as optical catheter and endoscopes, and the like.

For example, a programmable H-PDLC optical assembly may be integrated into a camera for achieving multiple selectable focal lengths. The programmable camera allows users to seamlessly and speedily change focal lengths while capturing images at varying distances. In contrast with traditional zoom lenses, the programmable H-PDLC optical assembly built according to an embodiment of the invention is fast, provides a more accurate focus, has lower power consumption, fewer optical elements and is easily miniaturized.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications; they thereby enable others skilled in the art to best utilize the invention and various embodiments with various modifications as are suited to the particular use contemplated. It is intended that the following claims and their equivalents define the scope of the invention.

What is claimed is:

1. An optical imaging apparatus having a variable focal length, comprising:
a plurality of holographic polymer dispersed liquid crystal (H-PDLC) lenses arranged in a stack, each lens having a unique focal length; and
a programmable controller configured to independently address a plurality of voltages to the plurality of H-PDLC lenses to achieve a plurality of focal lengths, the number of focal lengths greater than the number of H-PDLC lenses.

2. The optical imaging apparatus of claim 1, further comprising a fixed lens placed in front of the plurality of H-PDLC lenses.

3. The optical imaging apparatus of claim 1, further comprising a prism placed after the plurality of H-PDLC lenses in the package.

4. The optical imaging apparatus of claim 1, wherein each H-PDLC lens in the plurality of H-PDLC lenses comprises a PDLC cell.

5. The optical imaging apparatus of claim 4, wherein the PDLC cell has a thickness ranging from 5 to 10 μm.

6. The optical imaging apparatus of claim 1, wherein the plurality of voltages range from 5 to 50 Volts.

7. The optical imaging apparatus of claim 1, wherein the plurality of H-PDLC lenses and the controller are integrated in a package.

8. The optical imaging apparatus of claim 7, wherein the plurality of H-PDLC lenses comprises a plurality of lenses selected from the group consisting of: off-axis H-PDLC lenses; and on-axis H-PDLC lenses.

9. An integrated multi-lens apparatus, comprising:
N integrated lens layers, each layer having a holographic polymer dispersed liquid crystal (H-PDLC) lens having a unique focal length; and
a programmable controller configured to apply N voltages to the N integrated lens layers to achieve 2^{N} focal lengths, wherein N is an integer of at least two.

10. The integrated multi-lens apparatus of claim 9, wherein the N integrated lens layers and the controller are integrated in a package.

11. The integrated multi-lens apparatus of claim 9, further comprising a fixed lens placed in front of the N integrated lens layers.

12. The integrated multi-lens apparatus of claim 9, further comprising a prism placed after the N integrated lens layers.

13. The integrated multi-lens apparatus of claim 9, wherein the N integrated lens layers comprise N lenses selected from the group consisting of: off-axis H-PDLC lenses; and on-axis H-PDLC lenses.

14. The integrated multi-lens apparatus of claim 9, wherein the N voltages are independently addressable.

15. A method of fabrication of an optical imaging apparatus having a variable focal length, comprising:
fabricating a plurality of holographic polymer dispersed liquid crystal (H-PDLC) lenses, each lens having a unique focal length;
stacking the plurality of H-PDLC lenses in a package; and
providing a programmable controller in the package to apply a plurality of voltages to the plurality of H-PDLC lenses to achieve a plurality of focal lengths, the number of focal lengths greater than the number of H-PDLC lenses.

16. The method of claim 15, further comprising inserting a fixed lens in front of the plurality of H-PDLC lenses in the package.

17. The method of claim 15, further comprising inserting a prism after the plurality of H-PDLC lenses in the package.

18. The method of claim 15, wherein fabricating a plurality of H-PDLC lenses comprises forming a plurality of PDLC cells.

19. The method of claim 18, further comprising recording a plurality of holographic fringes onto the plurality of PDLC cells.

20. The method of claim 19, wherein recording a plurality of holographic fringes onto the plurality of PDLC cells comprises using an achromatic lens to record a holographic fringe onto each PDLC cell.

21. The method of claim 20, further comprising varying a distance between the achromatic lens and each PDLC cell to generate a unique focal length for each PDLC cell.

22. The method of claim 15, wherein the plurality of H-PDLC lenses comprises N lenses, wherein N is an integer of at least 2.

23. The method of claim 22, wherein the plurality of focal lengths comprises 2^{N} focal lengths.

24. A programmable multi-focal camera, comprising:
an image sensor to generate image data from an optical image; and
a programmable optical assembly to capture the optical image, the programmable optical assembly comprising:
a plurality of holographic polymer dispersed liquid crystal (H-PDLC) lenses arranged in a stack, each lens having a unique focal length; and
a programmable controller configured to independently address a plurality of voltages to the plurality of H-PDLC lenses to achieve a plurality of focal lengths, the number of focal lengths greater than the number of H-PDLC lenses.

25. The programmable multi-focal camera of claim 24, wherein the programmable controller comprises an input for selecting a focal length from the plurality of focal lengths.
